(19) United States
(12) Patent Application Publication
(10) Pub. No.: US 2026/0049228 A1
(43) Pub. Date: Feb. 19, 2026

(54) LED UV CURING COMPOSITION

(71) Applicant: ENGINEERED CUSTOM COATINGS, LLC, Pewaukee, WI (US)

(72) Inventors: Pyotr SMELYANSKY, Buffalo Grove, IL (US); Kenneth W. BURTON, JR., DeKalb, IL (US)

(73) Assignee: ENGINEERED CUSTOM COATINGS, LLC, Pewaukee, WI (US)

(21) Appl. No.: 18/802,159

(22) Filed: Aug. 13, 2024

(51) Int. Cl. C09D 133/08; B05D 3/06; C09D 4/00; C09D 7/61; C09D 7/63

(52) U.S. Cl. CPC C09D 133/08; B05D 3/067; C09D 4/00; C09D 7/61; C09D 7/63; B05D 2502/00; B05D 2601/22

(57) ABSTRACT

Disclosed is an LED UV curable coating composition comprising one or more multifunctional aliphatic acrylate oligomers having an acrylate functionality of 2 or more, one or more monofunctional acrylate monomers, one or more difunctional acrylate monomers, methyl and/or butyl methacrylate, an aliphatic acrylate with primary hydroxyl groups, one or more multi-functional amino acrylates, one or more pigments, one or more photoinitiators, a methacrylate modified acidic adhesion agent, one or more UV absorbers, one or more flatteners, and one or more defoamers, and methods thereof.

### BACKGROUND OF THE INVENTION

Ultraviolet (UV) curing is a well-known technique for coating composite substrates and/or exterior grade materials such as window profiles, cladding, siding, fencing, decking, or roofing with a curable composition. Despite its widespread use, UV curing has several drawbacks, such as long curing times and high levels of energy consumption.

Therefore, attempts have been made to develop improved curable compositions that can be cured using light emitting diodes (LEDs), which allow for faster curing times and lower levels of energy consumption. However, there remains an unmet need for curable compositions that can be cured via UV-LED radiation. The invention disclosed herein provides such a LED UV curable composition. This and other advantages of the invention, as well as additional inventive features, will be apparent from the description of the invention provided herein.

### BRIEF SUMMARY OF THE INVENTION

In one aspect, the invention provides an LED UV curable coating composition comprising:
(1) one or more multifunctional aliphatic acrylate oligomers having an acrylate functionality of 2 or more;
(2) one or more monofunctional acrylate monomers;
(3) one or more difunctional acrylate monomers;
(4) methyl and/or butyl methacrylate;
(5) an aliphatic acrylate with primary hydroxyl groups;
(6) one or more multi-functional amino acrylates;
(7) one or more pigments;
(8) one or more photoinitiators;
(9) a methacrylate modified acidic adhesion agent; and
(10) one or more additives selected from the group consisting of UV absorbers, flatteners, and defoamers.

In another aspect, the invention provides a method for providing a substrate with a cured coating comprising applying the LED UV curable coating composition of the present invention onto a substrate and curing the curable coating composition by LED UV.

The invention provides advantages, for example, it is possible to provide deep cure as well as surface cure with the coating composition of the present invention. In particular, it is possible to inhibit undesirable free radical process.

Further and alternative aspects and features of the disclosed invention will be apparent from the following detailed description. As will be appreciated, the methods disclosed herein are capable of being carried out and used in other and different aspects, and capable of being modified in various respects. Accordingly, it is to be understood that both the foregoing general description and the following detailed description are only exemplary and explanatory and do not restrict in any way the scope of the claimed invention.

### DETAILED DESCRIPTION OF THE INVENTION

The invention provides an LED UV curable coating composition comprising:
(1) one or more multifunctional aliphatic acrylate oligomers having an acrylate functionality of 2 or more;
(2) one or more monofunctional acrylate monomers;
(3) one or more difunctional acrylate monomers;
(4) methyl and/or butyl methacrylate;
(5) an aliphatic acrylate with primary hydroxyl groups;
(6) one or more multi-functional amino acrylates;
(7) one or more pigments;
(8) one or more photoinitiators;
(9) a methacrylate modified acidic adhesion agent; and
(10) one or more additives selected from the group consisting of UV absorbers, flatteners, and defoamers.

It has been discovered that LED-UV curable coating compositions comprising items (1)-(10) above provide performance advantages relative to existing coatings, such as quicker curing times and lower energy consumption during the curing process.

The curable coating composition of the present invention comprises one or more multifunctional aliphatic acrylate oligomers. In an aspect, the multifunctional aliphatic acrylate oligomers can be difunctional acrylate oligomers, trifunctional acrylate oligomers, octa-functional acrylate oligomers, deca-functional acrylate oligomers, or combinations thereof. As used herein, unless otherwise indicated, “difunctional acrylate oligomers” refers to oligomers with two curable acrylate functionalities; “trifunctional acrylate oligomers” refers to oligomers with three curable acrylate functionalities; “octa-functional acrylate oligomers” refers to oligomers with eight curable acrylate functionalities; and “deca-functional acrylate oligomers” refers to oligomers with ten curable acrylate functionalities.

In some aspects, the difunctional acrylate oligomers can comprise aliphatic urethane diacrylate and the trifunctional acrylate oligomers may comprise aliphatic urethane triacrylate. For example, some such difunctional acrylate oligomers are available from Allnex as Ebercyl® 284, Ebercyl® 8402, Ebercyl® 8411; from IGM Resins as Photomer® 6620 or Photomer® 6230; from Rahn as Genomer® 4267; Genomer® 4215, and Genomer® 4217; from Eternal Materials as Etercure® 611B-85 or Etercure® 611A-85, or combinations thereof. Some such trifunctional acrylate oligomers are available from IGM Resins as Photomer® 6019, from Eternal Materials as Etercure® 6130B-80 or Etercure® 6134B-80, or combinations thereof. Some such octa-functional oligomers are available from Eternal Materials as Etercure® DR-UO95. Some such deca-functional oligomers are available from Eternal Materials as Etercure® DR-U591. In other aspects, the multifunctional aliphatic acrylate oligomers may be aliphatic and aromatic urethane acrylates, epoxy acrylates, melamine acrylates, polyester acrylates, polyether acrylates, silicone acrylates, dendritic acrylates, polybutadiene acrylates, amine acrylates, acrylic acrylates, amido and spiro ortho carbonate esters, or combinations thereof.

In some aspects, the multifunctional aliphatic acrylate oligomers have an average molecular weight from about 1,000 to about 10,000, e.g., about 1,000, about 1,250, about 1,500, about 1,750, about 2,000, about 2,250, about 2,500, about 2,750, about 3,000, about 3,250, about 3,500, about 3,750, about 4,000, about 4,250, about 4,500, about 4,750, about 5,000, about 5,250 about 5,500, about 5,750, about 6,000, about 6,250, about 6,500, about 6,750, about 7,000, about 7,250, about 7,500, about 7,750, about 8,000, about 8,250, about 8,500, about 8,750, about 9,000, about 9,250, about 9,500, about 9,750 or about 10,000.

In some aspects, the multifunctional aliphatic acrylate oligomers comprise about 3% to about 10% by weight of the composition, e.g., about 3% by weight, about 3.5% by weight, about 4% by weight, about 4.5% by weight, about 5% by weight, about 5.5% by weight, about 6% by weight, about 6.5% by weight, about 7% by weight, about 7.5% by weight, about 8% by weight, about 8.5% by weight, about 9% by weight, about 9.5% by weight, or about 10% by weight.

The curable coating composition of the present invention further comprises one or more monomers selected from monofunctional acrylate monomers, difunctional acrylate monomers, or a combination thereof. As used herein, unless otherwise indicated, “monofunctional acrylate monomers” refers to monomers with one acrylate functionality and “difunctional acrylate monomers” refers to monomers with two acrylate functionalities. In some aspects, the monofunctional acrylate monomers may be isobornyl acrylate, isodecyl acrylate, isodecyl methacrylate, octyl decyl acrylate, or combinations thereof. In other aspects, the difunctional acrylate monomers may be 1,6-hexanediol diacrylate, tripropylene glycol diacrylate, dipropylene glycol diacrylate, or combinations thereof. For example, some such monofunctional acrylate monomers are available from Miwon Specialty Chemical as Miramer® M1140 or Miramer® M130; from Rahn as Genomer® 1121, Genomer® 1121M, or Miramer® M130; from Sartomers as SR506 NS; from Eternal Materials as Etermer® EM 70, Etermer® EM 2191, Etermer® EM 219, or Etermer® EM 309; and from IGM Resins as Photomer® 4012, Photomer® 4810, or Photomer® 4808, or combinations thereof. Some such difunctional acrylate monomers are available from Miwon Specialty Chemical as Miramer® M200, Miramer® M220, or Miramer® M222; from IGM Resins as Photomer® 4017, Photomer® 4061, or Photomer® 4226; from Eternal Materials as Etermer® EM 221, Etermer® EM 223, or Etermer® EM 222; from Allnex as HDDA; from Rahn as Miramer® M200; from Sartomer as SR236, or combinations thereof.

In other aspects, the acrylate monomers may be styrene, alpha-methylstyrene, substituted styrene, vinyl ester, vinyl ether, N-vinyl-2-pyrrolidone, (meth)acrylamide, N-substituted (meth)acrylamide, octyl(meth)acrylate, nonylphenol ethoxylate(meth)acrylate, isononyl(meth)acrylate, isobornyl(meth)acrylate, 2-(2-ethoxyethoxy)ethyl(meth)acrylate, 2-ethylhexyl(meth)acrylate, lauryl(meth)acrylate, beta-carboxyethyl(meth)acrylate, isobutyl(meth)acrylate, cycloaliphatic epoxide, alpha-epoxide, 2-hydroxyethyl(meth)acrylate, (meth)acrylonitrile, maleic anhydride, itaconic acid, isodecyl(meth)acrylate, dodecyl(meth)acrylate, n-butyl(meth)acrylate, methyl(meth)acrylate, hexyl(meth)acrylate, (meth)acrylic acid, N-vinylcaprolactam, N-vinylformamide, stearyl(meth)acrylate, hydroxy functional caprolactone ester(meth)acrylate, isooctyl(meth)acrylate, hydroxyethyl(meth)acrylate, hydroxymethyl(meth)acrylate, hydroxypropyl(meth)acrylate, hydroxyisopropyl(meth)acrylate, hydroxybutyl(meth)acrylate, hydroxyisobutyl(meth)acrylate, tetrahydrofurfuryl(meth)acrylate, ethylene glycol di(meth)acrylate, hexanediol di(meth)acrylate, triethylene glycol di(meth)acrylate, tetraethylene glycol di(meth)acrylate, dipropylene glycol di(meth)acrylate, and alkoxylated polyol derived diacrylates, such as propoxylated neopentyl glycol diacrylate, neopentyl glycol di(meth)acrylate, or combinations thereof (wherein “(meth)acrylate” refers to an acrylate and/or a methacrylate).

In some aspects, the combination of monofunctional acrylate monomers and difunctional acrylate monomers can comprise about 30% to about 40% by weight of the composition, e.g., about 30% by weight, about 31% by weight, about 32% by weight, about 33% by weight, about 34% by weight, about 35% by weight, about 36% by weight, about 37% by weight, about 38% by weight, about 39% by weight, or about 40% by weight.

The curable coating composition of the present invention further comprises methyl and/or butyl methacrylate. For example, some such methyl and/or butyl methacrylate are available from Roehm GmbH as Degalan® LP 64/12; from Dow Chemicals as Paraloid® B-66; from Mitsubishi Chemical as Dianal® BR-106, or combinations thereof. In some aspects, the methyl and/or butyl methacrylate may comprise about 3% to about 10% by weight of the composition, e.g., about 3% by weight, about 3.5% by weight, about 4% by weight, about 4.5% by weight, about 5% by weight, about 5.5% by weight, about 6% by weight, about 6.5% by weight, about 7% by weight, about 7.5% by weight, about 8% by weight, about 8.5% by weight, about 9% by weight, about 9.5% by weight, or about 10% by weight.

The curable coating composition of the present invention further comprises an aliphatic acrylate with primary hydroxyl groups. In certain aspects, the aliphatic acrylate with primary hydroxyl groups is urethane acrylate. For example, some such aliphatic acrylate with primary hydroxyl groups are available from Allnex as Ebercyl® 8210, from Rahn as Urethane Acrylate 00-022, or combinations thereof. In some aspects, the aliphatic acrylate with primary hydroxyl groups comprises about 5% by weight to about 10% by weight of the composition, e.g., about 5% by weight, about 5.5% by weight, about 6% by weight, about 6.5% by weight, about 7% by weight, about 7.5% by weight, about 8% by weight, about 8.5% by weight, about 9% by weight, about 9.5% by weight, or about 10% by weight.

The curable coating composition of the present invention further comprises one or more multi-functional amino acrylates. For example, some such multi-functional amino acrylates are available from Allnex as Ebercyl® LED 03, Ebercyl® LED 04, Ebercyl® LED 05, or combinations thereof. In some aspects, the multi-functional amino acrylates can comprise about 5% by weight to about 15% by weight of the composition, e.g., about 5% by weight, about 5.5% by weight, about 6% by weight, about 6.5% by weight, about 7% by weight, about 7.5% by weight, about 8% by weight, about 8.5% by weight, about 9% by weight, about 9.5% by weight, about 10% by weight, about 10.5% by weight, about 11% by weight, about 11.5% by weight, about 12% by weight, about 12.5% by weight, about 13% by weight, about 13.5% by weight, about 14% by weight, about 14.5% by weight, or about 15% by weight.

The curable coating composition of the present invention further comprises one or more pigments. In some aspects, the one or more pigments can be heat reflective pigments, inorganic-based pigments, organic-based pigments, raw umber pigments, or combinations thereof. In certain aspects, the inorganic-based pigments may be titanium dioxide, zinc white, zinc sulfide, lithopones, carbon black, iron manganese black, spinel black, chromium oxide, chromium oxide hydrate green, cobalt green, ultramarine green, cobalt blue, ultramarine blue, manganese blue, ultramarine violet, cobalt violet, manganese violet, red iron oxide, cadmium sulfoselenide, molybdate red, ultramarine red, brown iron oxide, mixed brown, spinel phases, corundum phases, chrome orange, yellow iron oxide, nickel titanium yellow, chrome titanium yellow, cadmium sulfide, cadmium zinc sulfide, chrome yellow, bismuth vanadate, iron oxide, diiron oxide, iron oxide hydrate, or combinations thereof. In other aspects, the organic-based pigments may be monoazo pigments, diazo pigments, anthraquinone pigments, benzimidazole pigments, quinacridone pigments, quinophthalone pigments, diketopyrrolovyrrole pigments, dioxazine pigments, indanthrone pigments, isoindoline pigments, isoindolinone pigments, azomethine pigments, thioindigo pigments, metal complex pigments, perinone pigments, perylene pigments, phthalocyanine pigments, aniline black, or combinations thereof.

For example, some such pigments are available from BASF as Paliogen® Black L 0086, Lumogen® Black K 0087, Lumogen® Black K 0088, Sicopa®l Black L 0095, Paliogen® Black S 0084, or Irgaphor® Black S 0100CF; from Sun Chemical as Spectrasense® Black L 0086, Spectrasense® Black L 0087, Spectrasense® Black L 0082, Spectrasense® Black L 0088, Spectrasense® Black L 0084, Spectrasense® IR 765, or Spectrasense® IR 788; from Shepherd Color Company as Dynamix® Black 30C933, Dynamix® Black 30C965, Dynamix® Black 30C940, Dynamix® Black 30C941, Dynamix® Blue 30C591, Dynamix® Blue 30C527, Dynamix® Blue 30C588, Dynamix® Yellow 30C119, Dynamix® Yellow 30C133, Dynamix® Yellow 30C152, Dynamix® Yellow 30C236, Dynamix® Green 30C612, Dynamix® Green 30C654, Dynamix® Green 30C659, Dynamix® Green 30C678, Dynamix® Orange 30C341, Arctic® Black 10P922, Arctic® Black 10G996, Arctic® Black 10P950, Arctic® Blue 211, Arctic® Blue 214, Arctic® Blue 385, Arctic® Blue 424, Arctic® Yellow 10P110, Arctic® Yellow 10P225, Arctic® Yellow 10P270, Arctic® Yellow 196, Arctic® Yellow 10P150, Arctic® Green 187B, Arctic® Green 179, Arctic® Green 10C650, Arctic® Orange 10P340, Arctic® Brown 19FDA, Arctic® Brown 10P857, Arctic® Brown 10P850, or combinations thereof.

In some aspects, the pigments can comprise about 1% by weight to about 40% by weight of the composition, e.g., about 1% by weight, about 2.5% by weight, about 5% by weight, about 7.5% by weight, about 10% by weight, about 12.5% by weight, about 15% by weight, about 17.5% by weight, about 20% by weight, about 22.5% by weight, about 25% by weight, about 27.5% by weight, about 30% by weight, about 32.5% by weight, about 35% by weight, about 37.5% by weight, or about 40% by weight.

The curable coating composition of the present invention further comprises one or more photoinitiators. In some aspects, the photoinitiators can be 1-hydroxycyclohexyl phenyl ketone, 2-hydroxy-2-methyl-1-phenyl-propan-1-one, diphenyl(2,4,6-trimethylbenzoyl)phosphine oxide, bis(2,4,6-trimethylbenzoyl)phenylphosphine oxide, difunctional oligomeric alpha hydroxyl ketones, difunctional ketosulphone, or combinations thereof. In other aspects, the photoinitiators can be benzophenone derivatives (e.g., 1-[4-(4-benzoyl-phenylsulfanyl)-phenyl]-2-methyl-2-(toluene-4-sulfonyl)-propan-1-one); acetophenone, acetophenone derivatives, for example, alpha-hydroxycycloalkyl phenyl ketones or dialkoxyacetophenones; alpha-hydroxy- or alpha-amino-acetophenone, for example, oligo-[2-hydroxy-2-methyl-1-[4-(1-methylvinyl)-phenyl]-propanone], 2-hydroxy-2-methyl-1-phenyl-1-propanone, 2-hydroxy-1-[4-(2-hydroxy-ethoxy)-phenyl]-2-methyl-propan-1-one, 2-methyl-1-[4-(methylthio)phenyl]-2-(4-morpholinyl)-propan-1-one, 2-dimethylamino-2-(4-methylbenzyl)-1-(4-morpholin-4-yl-phenyl)-butan-1-one, 2-benzyl-2-dimethylamimo-1-(3,4-dimethoxy-phenyl)-butan-1-one, 2-benzyl-2-dimethylamino-1-(4-morpholin-4-yl-phenyl)-butan-1-one, 2-methyl-1-(4-methylsulfanyl-phenyl)-2-morpholin-4-yl-propan-1-one; 1-hydroxy-cyclohexylphenylketone; 4-aroyl-1,3-dioxolanes; benzoin alkyl ethers and benzil ketals, for example, benzil dimethyl ketal, phenyl glyoxalates and derivatives thereof, for example, methylbenzoyl formate; dimeric phenyl glyoxalates, for example, oxo-phenyl-acetic acid 2-[2-(2-oxo-2-phenyl-acetoxy)-ethoxy]-ethyl ester; peresters, for example, benzophenone-tetracarboxylic acid peresters; monoacylphosphine oxides, for example, (2,4,6-trimethylbenzoyl)-diphenyl-phosphine oxide or phenyl-(2,4,6-trimethylbenzoyl)-phosphinic acid ethyl ester, bisacylphosphine oxides, for example, bis(2,6-dimethoxybenzoyl)-(2,4,4-trimethyl-pent-1-yl)phosphine oxide, phenylbis(2,4,6-trimethylbenzoyl)-phosphine oxide or bis(2,4,6-trimethylbenzoyl)-(2,4-dipentoxyphenyl)phosphine oxide, trisacylphosphine oxides; halomethyltriazines, for example, 2-[2-(4-methoxy-phenyl)-vinyl]-4,6-bis-trichloromethyl-[1,3,5]triazine, 2-(4-methoxy-phenyl)-4,6-bis-trichloromethyl-[1,3,5]triazine, 2-(3,4-dimethoxy-phenyl)-4,6-bis-trichloromethyl-[1,3,5]triazine, 2-methyl-4,6-bis-trichloromethyl-[1,3,5]triazine; hexaarylbisimidazole/coinitiator systems, for example, ortho-chlorohexaphenyl-bisimidazole together with 2-mercaptobenzthiazole; ferrocenium compounds or titanocenes, for example, dicyclopentadienyl bis(2,6-difluoro-3-pyrrolo-phenyl)titanium; and borate photoinitiators or O-acyloxime photoinitiators, or combinations thereof, as described, for example, as described in U.S. Pat. No. 8,304,032.

For example, some such photoinitiators are available from Eternal Materials as PI-184, PI-1173, and PI-TPO; from Rahn as Genocure® CPK and Genocure® TPO; from IGM Resins as Omnirad® 184, Omnirad® 1173, Omnirad® TPO, Omnirad® 819, Esacure® ONE, and Esacure® 1001 M; from Double Bond Chemicals as Doublecure® 1819, or combinations thereof. In some aspects, the photoinitiators comprise about 5% by weight to about 15% by weight of the composition, e.g., about 5% by weight, about 5.5% by weight, about 6% by weight, about 6.5% by weight, about 7% by weight, about 7.5% by weight, about 8% by weight, about 8.5% by weight, about 9% by weight, about 9.5% by weight, about 10% by weight, about 10.5% by weight, about 11% by weight, about 11.5% by weight, about 12% by weight, about 12.5% by weight, about 13% by weight, about 13.5% by weight, about 14% by weight, about 14.5% by weight, or about 15% by weight.

The curable coating composition of the present invention further comprises a methacrylate modified acidic adhesion agent. In some aspects, the methacrylate modified acidic adhesion agent can be a monofunctional acid methacrylate, 2-hydroxyethyl methacrylate phosphate, a difunctional acid methacrylate, a methacrylated phosphate ester, or combinations thereof. For example, some such methacrylate modified acidic adhesion agents are available from Allnex as Ebercyl® 168, from Eternal Materials as Etermer® EM 39, from IGM Resins as Photomer® 2203, from Rahn as Genorad® 40, or combinations thereof. In some aspects, the methacrylate modified acidic adhesion agents comprise about 2% to about 10% by weight of the composition, e.g., about 2% by weight, about 2.5% by weight, about 3% by weight, about 3.5% by weight, about 4% by weight, about 4.5% by weight, about 5% by weight, about 5.5% by weight, about 6% by weight, about 6.5% by weight, about 7% by weight, about 7.5% by weight, about 8% by weight, about 8.5% by weight, about 9% by weight, about 9.5% by weight, or about 10% by weight.

The curable coating composition of the present invention further comprises one or more UV absorbers. In some aspects, the UV absorbers can be a liquid hindered amine light stabilizer, hydroxyphenyl-triazine, hydroxyphenyl benzotriazole, or combinations thereof. For example, some such UV absorbers are available from BASF as Tinuvin® 123, Tinuvin® 292, Tinuvin® 479, Tinuvin® 1130, or combinations thereof. In some aspects, the UV absorbers comprise about 2% to about 6% by weight of the composition, e.g., about 2% by weight, about 2.25% by weight, about 2.5% by weight, about 2.75% by weight, about 3% by weight, about 3.25% by weight, about 3.5% by weight, about 3.75% by weight, about 4% by weight, about 4.25% by weight, about 4.5% by weight, about 4.75% by weight, about 5% by weight, about 5.25% by weight, about 5.5% by weight, about 5.75% by weight, or about 6% by weight.

The curable coating composition of the present invention further comprises one or more flatteners. Any suitable flatteners can be used. In some aspects, the flatteners are synthetic amorphous silica. For example, some such flatteners are available from PQ Corporation as Gasil® UV70C, from Evonik as Acematt® 3600, or combinations thereof. In some aspects, the flatteners may comprise about 5% by weight to about 10% by weight of the composition, e.g., about 5% by weight, about 5.5% by weight, about 6% by weight, about 6.5% by weight, about 7% by weight, about 7.5% by weight, about 8% by weight, about 8.5% by weight, about 9% by weight, about 9.5% by weight, or about 10% by weight.

The curable coating composition of the present invention further comprises one or more defoamers. Any suitable defoamer can be used. In some aspects, the one or more defoamers are a silicone-free defoamer. For example, some such defoamers are available from BYK as BYK®-1790. In some aspects, the defoamers comprise about 0.2% to about 1.0% by weight of the composition, e.g., about 0.2% by weight, about 0.3% by weight, about 0.4% by weight, about 0.5% by weight, about 0.6% by weight, about 0.7% by weight, about 0.8% by weight, about 0.9% by weight, or about 1.0% by weight.

In some aspects, the curable coating composition contains a brown pigment, wherein the composition comprises:
(1) the one or more multifunctional aliphatic acrylate oligomers having an acrylate functionality of 2 or more comprise about 6.5% by weight of the composition;
(2) and (3) the one or more monofunctional acrylate monomers and the one or more difunctional acrylate monomers comprise about 34% by weight of the composition;
(4) the methyl and/or butyl methacrylate comprises about 4% by weight of the composition;
(5) the aliphatic acrylate with primary hydroxyl groups comprises about 10% by weight of the composition;
(6) the one or more multi-functional amino acrylates comprise about 10% by weight of the composition;
(7) the one or more pigments comprise about 10% by weight of the composition;
(8) the one or more photoinitiators comprise about 9% by weight of the composition;
(9) the methacrylate modified acidic adhesion agent comprises about 4% by weight of the composition; and
(10) the UV absorbers comprise about 4% by weight of the composition, the flatteners comprise about 8% by weight of the composition, and the additive as defoamers comprise about 0.5% by weight of the composition.

In some aspects, the curable coating composition contains a black pigment, wherein the composition comprises:
(1) the one or more multifunctional aliphatic acrylate oligomers having an acrylate functionality of 2 or more comprise about 3% by weight of the composition;
(2) and (3) the one or more monofunctional acrylate monomers and the one or more difunctional acrylate monomers comprise about 39.5% by weight of the composition;
(4) the methyl and/or butyl methacrylate comprises about 5% by weight of the composition;
(5) the aliphatic acrylate with primary hydroxyl groups comprises about 5% by weight of the composition;
(6) the one or more multi-functional amino acrylates comprise about 10% by weight of the composition;
(7) the one or more pigments comprise about 10% by weight of the composition;
(8) the one or more photoinitiators comprise about 10% by weight of the composition;
(9) the methacrylate modified acidic adhesion agent comprises about 5% by weight of the composition; and
(10) the UV absorbers comprise about 4% by weight of the composition, the flatteners comprise about 8% by weight of the composition, and the additive as defoamers comprise about 0.5% by weight of the composition.

The present invention also provides a method for providing a substrate with a cured coating comprising applying the LED UV curable coating composition according to the present invention onto the substrate and curing the curable coating composition by LED UV. In some aspects, the substrate is a plastic composite substrate, a PVC composite substrate, or an exterior grade material. For example, the composite substrate can be bitumen, cements, polymers (e.g., PVC), metals and ceramics, reinforcement and/or filler materials include, for example, aggregate, sand, crushed stone, ground minerals, calcium carbonate, calcium sulfate, aluminum trihydrate, talc, cellulosics (e.g., pond sludge, wood flour, sawdust, newspapers, alfalfa, wood pulp, wood chips, wood fibers, paper, cardboard and straw), steel reinforcing bars, glass fibers, C-glass, E-glass, S-glass, quartz, polymer fibers, nylon based polymer fibers, aramid fibers, polyethylene based polymer fibers, natural fibers, hemp fibers, sisal fibers, carbon fibers, rayon based carbon fibers, polyacrylonitrile-based carbon fibers, pitch-based carbon fibers, ceramic fibers, alumina silica mixtures, silicon carbide, boron, textiles, felts, woven fabrics, plain weave fabrics, twill weave fabrics, satin weave fabrics, and stitched construction fabrics, as described, for example, as described in U.S. Pat. No. 8,304,032. In certain aspects, the polymers may be polyethylene (e.g., low-density (LDPE) and high-density polyethylene (HDPE)), polypropylene (PP), polystyrene (PS), acrylonitrile butadiene styrene (ABS), poly(polyethylene terephthalate), polyester, polyamides, polyvinyl chloride (PVC), polyurethane, polycarbonate, poly(vinylidene chloride), poly(methyl methacrylate), polytetrafluoroethylene, polyetheretherketone, polyetherimide, phenolics, phenol formaldehyde, urea formaldehyde, melamine formaldehyde, melamine formaldehyde, polylactic acid, plastarch material, or combinations thereof. In some aspects, the exterior grade material is a window profile, a cladding, a siding, a fencing, a decking, or a roofing.

The curing method of the present invention produces a cured pigmented coating having a dry film thickness of about 1.0 mil to about 3.0 mil, e.g., about 1.0 mil, about 1.2 mil, about 1.4 mil, about 1.6 mil, about 1.8 mil, about 2.0 mil, about 2.2 mil, about 2.4 mil, about 2.6 mil, about 2.8 mil, or about 3.0 mil.

The curing method of the present invention operates via a condensation polymerization mechanism, ring opening polymerization mechanism, a free radical polymerization mechanism, or any suitable combination thereof.

Aspects of the invention described herein may be beneficial alone or in combination, with one or more other aspects. Without limiting the foregoing description, certain non-limiting aspects numbered 1-34 are provided below. As will be apparent to those of skill in the art upon reading this disclosure, each of the individually numbered aspects may be used or combined with any of the preceding or following individually numbered aspects. This is intended to provide support for all such combinations of aspects and is not limited to combinations of aspects explicitly provided below:
(1) An LED UV curable coating composition comprising:
(1) one or more multifunctional aliphatic acrylate oligomers having an acrylate functionality of 2 or more;
(2) one or more monofunctional acrylate monomers;
(3) one or more difunctional acrylate monomers;
(4) methyl and/or butyl methacrylate;
(5) an aliphatic acrylate with primary hydroxyl groups;
(6) one or more multi-functional amino acrylates;
(7) one or more pigments;
(8) one or more photoinitiators;
(9) a methacrylate modified acidic adhesion agent; and
(10) one or more additives selected from the group consisting of UV absorbers, flatteners, and defoamers.
(2) The LED UV curable coating composition of aspect (1), wherein the multifunctional aliphatic acrylate oligomers comprise difunctional acrylate oligomers, trifunctional acrylate oligomers, octa-functional acrylate oligomers, deca-functional acrylate oligomers, or a combination thereof.
(3) The LED UV curable coating composition of aspect (2), wherein the difunctional acrylate oligomers comprise aliphatic urethane diacrylate.
(4) The LED UV curable coating composition of aspect (2), wherein the trifunctional acrylate oligomers comprise aliphatic urethane triacrylate.
(5) The LED UV curable coating composition of any one of aspects (1)-(4), wherein the multifunctional aliphatic acrylate oligomers have an average molecular weight from about 1,000 to about 10,000.
(6) The LED UV curable coating composition of any one of aspects (1)-(5), wherein the monofunctional acrylate monomers are selected from the group consisting of isobornyl acrylate, isodecyl acrylate, isodecyl methacrylate, octyl decyl acrylate, or a combination thereof.
(7) The LED UV curable coating composition of any one of aspects (1)-(6), wherein the difunctional acrylate monomers are selected from the group consisting of 1,6-hexanediol diacrylate, tripropylene glycol diacrylate, dipropylene glycol diacrylate, or a combination thereof.
(8) The LED UV curable coating composition of any one of aspects (1)-(7), wherein the methyl methacrylate comprises about 3% to about 10% by weight of the composition.
(9) The LED UV curable coating composition of any one of aspects (1)-(8), wherein the butyl methacrylate comprises about 3% to about 10% by weight of the composition.
(10) The LED UV curable coating composition of any one of aspects (1)-(9), wherein the aliphatic acrylate with primary hydroxyl groups comprises urethane acrylate.
(11) The LED UV curable coating composition of any one of aspects (1)-(10), wherein the aliphatic acrylate with primary hydroxyl groups comprises about 5% to about 10% by weight of the composition.
(12) The LED UV curable coating composition of any one of aspects (1)-(11), wherein the multi-functional amino acrylate comprises about 5% to about 15% by weight of the composition.
(13) The LED UV curable coating composition of any one of aspects (1)-(12), wherein the pigments are selected from the group consisting of heat reflective pigments, inorganic-based pigments, organic-based pigments, or a combination thereof.
(14) The LED UV curable coating composition of aspect (13), wherein the inorganic-based pigment is titanium dioxide.
(15) The LED UV curable coating composition of any one of aspects (1)-(14), wherein the photoinitiators are selected from the group consisting of 1-hydroxycyclohexyl phenyl ketone, 2-hydroxy-2-methyl-1-phenyl-propan-1-one, diphenyl(2,4,6-trimethylbenzoyl)phosphine oxide, bis(2,4,6-trimethylbenzoyl)phenylphosphine oxide, difunctional oligomeric alpha hydroxyl ketones, difunctional ketosulphone, or a combination thereof.
(16) The LED UV curable coating composition of any one of aspects (1)-(15), wherein the methacrylate modified acidic adhesion agent is selected from the group consisting of a monofunctional acid methacrylate, 2-hydroxyethyl methacrylate phosphate, a difunctional acid methacrylate, a methacrylated phosphate ester, or a combination thereof.
(17) The LED UV curable coating composition of any one of aspects (1)-(16), wherein the UV absorbers are selected from the group consisting of a liquid hindered amine light stabilizer, hydroxyphenyl-triazine, hydroxyphenyl benzotriazole, or a combination thereof.
(18) The LED UV curable coating composition of any one of aspects (1)-(17), wherein the UV absorbers comprise about 2% to about 6% by weight of the composition.
(19) The LED UV curable coating composition of any one of aspects (1)-(18), wherein the flatteners are synthetic amorphous silica.
(20) The LED UV curable coating composition of any one of aspects (1)-(19), wherein the flatteners comprise about 5% to about 10% by weight of the composition.
(21) The LED UV curable coating composition of any one of aspects (1)-(20), wherein the defoamer is a silicone-free defoamer.
(22) The LED UV curable coating composition of any one of aspects (1)-(21), wherein the defoamer comprises about 0.2% to about 1.0% by weight of the composition.
(23) A method for providing a substrate with a cured coating comprising applying the LED UV curable coating composition according to any one of aspects (1)-(22) onto the substrate and curing the curable coating composition by LED UV.
(24) The method of aspect (23), wherein the substrate is a plastic composite substrate.
(25) The method of aspect (23), wherein the substrate is a PVC composite substrate.
(26) The method of aspect (23), wherein the substrate is an exterior grade material.
(27) The method of aspect (26), wherein the exterior grade material is selected from the group consisting of a window profile, a cladding, a siding, a fencing, a decking, or a roofing.
(28) The method of any one of aspects (23)-(27), wherein the curing produces a cured pigmented coating at 1.0-3.0 mil dry film thickness.
(29) The method of any one of aspects (23)-(28), wherein the mechanism by which the curable coating composition is cured comprises condensation, theoretical, free radical, or a combination thereof.
(30) The LED UV curable coating composition of any one of aspects (1)-(22), wherein:
(1) the one or more multifunctional aliphatic acrylate oligomers having an acrylate functionality of 2 or more comprise about 3% to about 10% by weight of the composition;
(2) and (3) the one or more monofunctional acrylate monomers and the one or more difunctional acrylate monomers comprise about 30% to about 40% by weight of the composition;
(4) the methyl and/or butyl methacrylate comprises about 3% to about 10% by weight of the composition;
(5) the aliphatic acrylate with primary hydroxyl groups comprises about 5% to about 10% by weight of the composition;
(6) the one or more multi-functional amino acrylates comprise about 5% to about 15% by weight of the composition;
(7) the one or more pigments comprise about 1% to about 40% by weight of the composition;
(8) the one or more photoinitiators comprise about 5% to about 15% by weight of the composition;
(9) the methacrylate modified acidic adhesion agent comprises about 2% to about 10% by weight of the composition; and
(10) the UV absorbers comprise about 2% to about 6% by weight of the composition, the flatteners comprise about 5% to about 10% by weight of the composition, and the additive as defoamers comprise about 0.2% to about 1.0% by weight of the composition.
(31) The LED UV curable coating composition of any one of aspects (1)-(22), wherein the coating composition contains a brown pigment.
(32) The LED UV curable coating composition of aspect (31), wherein:
(1) the one or more multifunctional aliphatic acrylate oligomers having an acrylate functionality of 2 or more comprise about 6.5% by weight of the composition;
(2) and (3) the one or more monofunctional acrylate monomers and the one or more difunctional acrylate monomers comprise about 34% by weight of the composition;
(4) the methyl and/or butyl methacrylate comprises about 4% by weight of the composition;
(5) the aliphatic acrylate with primary hydroxyl groups comprises about 10% by weight of the composition;
(6) the one or more multi-functional amino acrylates comprise about 10% by weight of the composition;
(7) the one or more pigments comprise about 10% by weight of the composition;
(8) the one or more photoinitiators comprise about 9% by weight of the composition;
(9) the methacrylate modified acidic adhesion agent comprises about 4% by weight of the composition; and
(10) the UV absorbers comprise about 4% by weight of the composition, the flatteners comprise about 8% by weight of the composition, and the additive as defoamers comprise about 0.5% by weight of the composition.
(33) The LED UV curable coating composition of any one of aspects (1)-(22), wherein the coating composition contains a black pigment.
(34) The LED UV curable coating composition of aspect (33), wherein:
(1) the one or more multifunctional aliphatic acrylate oligomers having an acrylate functionality of 2 or more comprise about 3% by weight of the composition;
(2) and (3) the one or more monofunctional acrylate monomers and the one or more difunctional acrylate monomers comprise about 39.5% by weight of the composition;
(4) the methyl and/or butyl methacrylate comprises about 5% by weight of the composition;
(5) the aliphatic acrylate with primary hydroxyl groups comprises about 5% by weight of the composition;
(6) the one or more multi-functional amino acrylates comprise about 10% by weight of the composition;
(7) the one or more pigments comprise about 10% by weight of the composition;
(8) the one or more photoinitiators comprise about 10% by weight of the composition;
(9) the methacrylate modified acidic adhesion agent comprises about 5% by weight of the composition; and
(10) the UV absorbers comprise about 4% by weight of the composition, the flatteners comprise about 8% by weight of the composition, and the additive as defoamers comprise about 0.5% by weight of the composition.

### EXAMPLES

These following examples further illustrate the invention but, of course, should not be construed as in any way limiting its scope.

### Example 1

This example illustrates a method for preparing an LED UV curable coating composition for LED brown color.

In this study, the following components were combined: (1) the one or more multifunctional aliphatic acrylate oligomers having an acrylate functionality of 2 or more comprise about 6.5% by weight of the composition; (2) and (3) the one or more monofunctional acrylate monomers and the one or more difunctional acrylate monomers comprise about 34% by weight of the composition; (4) the methyl and/or butyl methacrylate comprises about 4% by weight of the composition; (5) the aliphatic acrylate with primary hydroxyl groups comprises about 10% by weight of the composition; (6) the one or more multi-functional amino acrylates comprise about 10% by weight of the composition; (7) the one or more pigments comprise about 10% by weight of the composition; (8) the one or more photoinitiators comprise about 9% by weight of the composition; (9) the methacrylate modified acidic adhesion agent comprises about 4% by weight of the composition; and (10) the UV absorbers comprise about 4% by weight of the composition, the flatteners comprise about 8% by weight of the composition, and the additive as defoamers comprise about 0.5% by weight of the composition. Pigments are processed to proper fineness using various mills such as a ball, sand, and/or basket mills. All of the components of the composition are pre-dispersed using high speed mixing prior to milling.

### Example 2

This example illustrates a method for preparing an LED UV curable coating composition for LED black color.

In this study, the following components were combined: (1) the one or more multifunctional aliphatic acrylate oligomers having an acrylate functionality of 2 or more comprise about 3% by weight of the composition; (2) and (3) the one or more monofunctional acrylate monomers and the one or more difunctional acrylate monomers comprise about 39.5% by weight of the composition; (4) the methyl and/or butyl methacrylate comprises about 5% by weight of the composition; (5) the aliphatic acrylate with primary hydroxyl groups comprises about 5% by weight of the composition; (6) the one or more multi-functional amino acrylates comprise about 10% by weight of the composition; (7) the one or more pigments comprise about 10% by weight of the composition; (8) the one or more photoinitiators comprise about 10% by weight of the composition; (9) the methacrylate modified acidic adhesion agent comprises about 5% by weight of the composition; and (10) the UV absorbers comprise about 4% by weight of the composition, the flatteners comprise about 8% by weight of the composition, and the additive as defoamers comprise about 0.5% by weight of the composition. Pigments are processed to proper fineness using various mills such as a ball, sand, and/or basket mills. All of the components of the composition are pre-dispersed using high speed mixing prior to milling.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. An LED UV curable coating composition comprising:
(1) one or more multifunctional aliphatic acrylate oligomers having an acrylate functionality of 2 or more;
(2) one or more monofunctional acrylate monomers;
(3) one or more difunctional acrylate monomers;
(4) methyl and/or butyl methacrylate;
(5) an aliphatic acrylate with primary hydroxyl groups;
(6) one or more multi-functional amino acrylates;
(7) one or more pigments;
(8) one or more photoinitiators;
(9) a methacrylate modified acidic adhesion agent; and
(10) one or more additives selected from the group consisting of UV absorbers, flatteners, and defoamers.

2. The LED UV curable coating composition of claim 1, wherein the multifunctional aliphatic acrylate oligomers have an average molecular weight from about 1,000 to about 10,000 and comprise difunctional acrylate oligomers, trifunctional acrylate oligomers, octa-functional acrylate oligomers, deca-functional acrylate oligomers, or a combination thereof.

3. The LED UV curable coating composition of claim 2, wherein the difunctional acrylate oligomers comprise aliphatic urethane diacrylate and the trifunctional acrylate oligomers comprise aliphatic urethane triacrylate.

4-5. (canceled)

6. The LED UV curable coating composition of claim 1, wherein the monofunctional acrylate monomers are selected from the group consisting of isobornyl acrylate, isodecyl acrylate, isodecyl methacrylate, octyl decyl acrylate, and a combination thereof and the difunctional acrylate monomers are selected from the group consisting of 1,6-hexanediol diacrylate, tripropylene glycol diacrylate, dipropylene glycol diacrylate, and a combination thereof.

7. (canceled)

8. The LED UV curable coating composition of claim 1, wherein the methyl and/or butyl methacrylate comprises about 3% to about 10% by weight of the composition.

9. (canceled)

10. The LED UV curable coating composition of claim 1, wherein the aliphatic acrylate with primary hydroxyl groups comprises about 5% to about 10% by weight of the composition and is urethane acrylate.

11. (canceled)

12. The LED UV curable coating composition of claim 1, wherein the multi-functional amino acrylate comprises about 5% to about 15% by weight of the composition.

13. The LED UV curable coating composition of claim 1, wherein the pigments are selected from the group consisting of heat reflective pigments, inorganic-based pigments, organic-based pigments, and a combination thereof.

14. (canceled)

15. The LED UV curable coating composition of claim 1, wherein the photoinitiators are selected from the group consisting of 1-hydroxycyclohexyl phenyl ketone, 2-hydroxy-2-methyl-1-phenyl-propan-1-one, diphenyl(2,4,6-trimethylbenzoyl)phosphine oxide, bis(2,4,6-trimethylbenzoyl)phenylphosphine oxide, difunctional oligomeric alpha hydroxyl ketones, difunctional ketosulphone, and a combination thereof.

16. The LED UV curable coating composition of claim 1, wherein the methacrylate modified acidic adhesion agent is selected from the group consisting of a monofunctional acid methacrylate, 2-hydroxyethyl methacrylate phosphate, a difunctional acid methacrylate, a methacrylated phosphate ester, and a combination thereof.

17. The LED UV curable coating composition of claim 1, wherein the UV absorbers comprise about 2% to about 6% by weight of the composition and are selected from the group consisting of a liquid hindered amine light stabilizer, hydroxyphenyl-triazine, hydroxyphenyl benzotriazole, and a combination thereof.

18. (canceled)

19. The LED UV curable coating composition of claim 1, wherein the flatteners comprise about 5% to about 10% by weight of the composition and are synthetic amorphous silica.

20. (canceled)

21. The LED UV curable coating composition of claim 1, wherein the defoamer comprises about 0.2% to about 1.0% by weight of the composition and is a silicone-free defoamer.

22. (canceled)

23. A method for providing a substrate with a cured coating comprising applying the LED UV curable coating composition according to claim 1, onto the substrate and curing the curable coating composition by LED UV.

24. The method of claim 23, wherein the substrate is a plastic composite substrate, a PVC composite substrate, an exterior grade material, or a combination thereof.

25-26. (canceled)

27. The method of claim 24, wherein the exterior grade material is selected from the group consisting of a window profile, a cladding, a siding, a fencing, a decking, or a roofing.

28. The method of claim 24, wherein the curing produces a cured pigmented coating at 1.0-3.0 mil dry film thickness and wherein the mechanism by which the curable coating composition is cured comprises condensation, theoretical, free radical, or a combination thereof.

29. (canceled)

30. The LED UV curable coating composition of claim 1, wherein:
(1) the one or more multifunctional aliphatic acrylate oligomers having an acrylate functionality of 2 or more comprise about 3% to about 10% by weight of the composition;
(2) and (3) the one or more monofunctional acrylate monomers and the one or more difunctional acrylate monomers comprise about 30% to about 40% by weight of the composition;
(4) the methyl and/or butyl methacrylate comprises about 3% to about 10% by weight of the composition;
(5) the aliphatic acrylate with primary hydroxyl groups comprises about 5% to about 10% by weight of the composition;
(6) the one or more multi-functional amino acrylates comprise about 5% to about 15% by weight of the composition;
(7) the one or more pigments comprise about 1% to about 40% by weight of the composition;
(8) the one or more photoinitiators comprise about 5% to about 15% by weight of the composition;
(9) the methacrylate modified acidic adhesion agent comprises about 2% to about 10% by weight of the composition; and
(10) the UV absorbers comprise about 2% to about 6% by weight of the composition, the flatteners comprise about 5% to about 10% by weight of the composition, and the additive as defoamers comprise about 0.2% to about 1.0% by weight of the composition.

31. The LED UV curable coating composition of claim 1, wherein the coating composition contains a brown pigment, the composition comprising:
(1) the one or more multifunctional aliphatic acrylate oligomers having an acrylate functionality of 2 or more comprise about 6.5% by weight of the composition;
(2) and (3) the one or more monofunctional acrylate monomers and the one or more difunctional acrylate monomers comprise about 34% by weight of the composition;
(4) the methyl and/or butyl methacrylate comprises about 4% by weight of the composition;
(5) the aliphatic acrylate with primary hydroxyl groups comprises about 10% by weight of the composition;
(6) the one or more multi-functional amino acrylates comprise about 10% by weight of the composition;
(7) the one or more pigments comprise about 10% by weight of the composition;
(8) the one or more photoinitiators comprise about 9% by weight of the composition;
(9) the methacrylate modified acidic adhesion agent comprises about 4% by weight of the composition; and
(10) the UV absorbers comprise about 4% by weight of the composition, the flatteners comprise about 8% by weight of the composition, and the additive as defoamers comprise about 0.5% by weight of the composition.

32. (canceled)

33. The LED UV curable coating composition of claim 1, wherein the coating composition contains a black pigment, the composition comprising:
(1) the one or more multifunctional aliphatic acrylate oligomers having an acrylate functionality of 2 or more comprise about 3% by weight of the composition;
(2) and (3) the one or more monofunctional acrylate monomers and the one or more difunctional acrylate monomers comprise about 39.5% by weight of the composition;
(4) the methyl and/or butyl methacrylate comprises about 5% by weight of the composition;
(5) the aliphatic acrylate with primary hydroxyl groups comprises about 5% by weight of the composition;
(6) the one or more multi-functional amino acrylates comprise about 10% by weight of the composition;
(7) the one or more pigments comprise about 10% by weight of the composition;
(8) the one or more photoinitiators comprise about 10% by weight of the composition;
(9) the methacrylate modified acidic adhesion agent comprises about 5% by weight of the composition; and
(10) the UV absorbers comprise about 4% by weight of the composition, the flatteners comprise about 8% by weight of the composition, and the additive as defoamers comprise about 0.5% by weight of the composition.

34. (canceled)
